(19) United States
(12) Patent Application Publication
(10) Pub. No.: US 2006/0109745 A1
(43) Pub. Date: May 25, 2006

(54) System and method for underwater target detection from broadband target returns

(76) Inventors: John V. Bouyoucos, Rochester, NY (US); Robert F. DeLaCroix, Penfield, NY (US); David P. Hollinger, Avon, NY (US)

Correspondence Address: Martin LuKacher, Patent Counsel;Hydroacoustics Inc., 999 Lehigh Station Road, P.O. Box 23447, Rochester, NY, 14692-3447, US

(21) Appl. No.: 10/996,008

(22) Filed: Nov. 23, 2004

(51) Int. Cl. G01S 15/02

(52) U.S. Cl. 367/135

(57) ABSTRACT

The probability of detection of an underwater moving target is enhanced by the selective summing of a multiplicity of reverberation suppressed, moving target detections, each appearing in a different and non-overlapping, narrow frequency band of a unitary, broadband transmission. The motion-sensitive target echoes are the result of a multiple-pulse broadband (SONAR) transmission. These broadband received echoes are bandpass filtered to form a set of narrow (e.g., 50 Hz) frequency bands extending over the full bandwidth of the transmission. These narrow band returns are then matched-filtered against a set of moving target replicas. Selected ones of these band-limited, matched-filtered returns are then summed together. The summed result can contribute to an enhanced probability that a unitary, moving target has been detected.

### DESCRIPTION

The present invention relates to methods and systems for detection of targets, especially underwater targets, and particularly to such systems and methods using matched filter processing of a target return from a broad frequency band acoustic transmission, such as may result from the transmission of a broadband pulse train from an airgun source array.

It is a feature of this invention to improve upon the system described in U.S. Pat. No. 6,771,561 issued Aug. 3, 2004 to J. V. Bouyoucos, et al in which a multiplicity of narrow frequency bands extracted from the broadband return are simultaneously matched filter processed to identify a moving target and the outputs from the band or bands which provide the best target response are used for target detection. The improvement is obtained by summing such selected band outputs and by using the summed outputs to enhance the probability of target detection. Such enhanced detection may be afforded by visual displays which graphically identify the enhancement achieved by the summing process.

It is a further feature of the invention to improve sonar detections as might be present in a multiplicity of analysis bands, such as may be provided by a bank of matched filter processors, by reducing the need for the sonar operator to focus on a large number of such bands; the improvement resulting from band summing which provides both an enhanced and simplified detection process. Such enhancement is especially useful when the receive array provides multiple beam outputs, each from a different azimuthal direction, thereby requiring the separate processing of a multiplicity of beam returns.

As described in the above referenced Bouyoucos, et al patent, a broadband train of closely-spaced, precisely timed impulsive events is transmitted underwater to detect a moving submarine target. For shallow water, reverberant environments the preferred frequency range may extend from 50 Hz to 600 Hz. The pulse train intercepts the moving submarine which reflects a time-compressed (closing range) or time-expanded (opening range) pulse train relative to the reflections from stationary reverberators. The reflected energy is received and stored in a memory bank. It is subsequently processed by matched filtering to suppress stationary reverberant returns and to identify moving targets. This procedure first divides the returning broadband energy into a series of contiguous, narrow (e.g., 50 Hz) frequency bands covering the bandwidth of the transmission. These 50 Hz band returns are individually matched filter processed against stored replicas of the transmitted pulse train. These replicas are individually time compressed or time stretched to address the impact of the closing or receding target's motion on the reflection of the incident pulse train. A match in the timing response of the received pulse train with the timing of a member of the replica bank results in an enhanced signal output identifying a moving target with a defined velocity.

This procedure is repeated for all of the 50 Hz frequency bands constituting the broadband transmitted signal, and for each beam from the sonar receive array.

In accordance with the invention there is provided a matched filter processing routine in which multiple bands (e.g., 50 Hz bands) are simultaneously matched filtered to provide the sonar operator with a direct and immediate enhancement of detection probability on his sonar display through the direct summing of the matched filter outputs from selected ones of the 50 Hz bands.

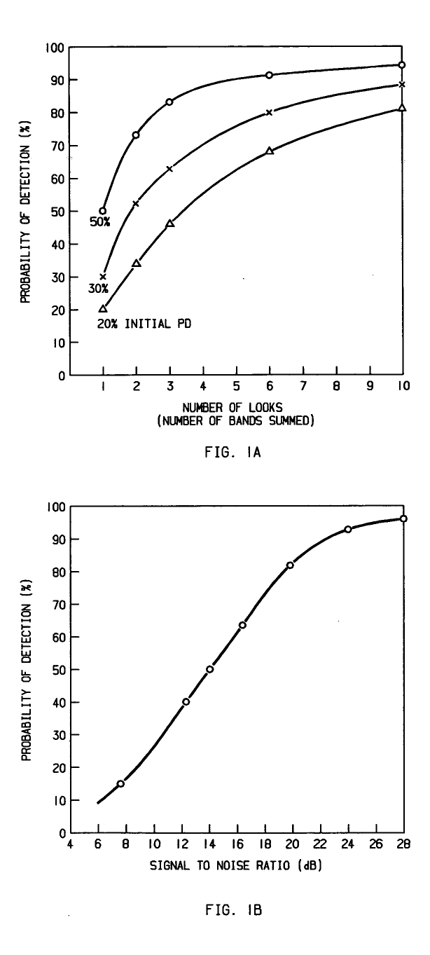

It has been discovered according to the invention that each of the detections of a target exhibiting the same velocity in separate 50 Hz frequency bands provides an “independent look” at the target. Summing selected detection band outputs simultaneously can provide enhancement in detection probability in accordance with the principle of multiple looks. The application of multiple independent looks to the enhancement of probability of detection has been documented in Radar Detection by J. V. DiFranco and W. L. Rubin, Prentice Hall, Electrical Engineering Systems (sections 11.2 and 11.3 of chapter 11). This enhancement is illustrated in FIG. 1A which plots the approximate improvement in probability of detection (PD) for multiple looks where the first “look” has a probability of detection of 50% for the top curve, 30% for the middle curve, and 20% for the bottom curve.

It can be seen that with three “looks” (each at a 50% PD) the detection probability has increased to about 80%. A further increase in the number of “looks” will further elevate PD, but at a much slower rate. If the initial PD is only 30%, the three “looks” raises PD to above 60%. With 6 “looks” the PD has increased to about 80%. Further if the initial PD is only 20%, 6 “looks” raises the PD to nearly 70%.

The probability of detection (PD) vs signal to noise ratio for a single look is illustrated in FIG. 1B. Note that a 14 dB signal to noise ratio corresponds to a PD of about 50%; an 11 dB signal to noise ratio corresponds to a PD of about 30%; and a 9 dB signal to noise ratio corresponds to a PD of about 20%. These signal to noise ratios relate to the starting points of the curves in FIG. 1A.

FIG. 1A is simplified in that a similar probability of detection for each look is used along any one curve. Nevertheless FIG. 1A shows that there is a strong enhancement of overall detection probability resulting from the combination, by summation, of a small number of detections in different frequency bands, each at relatively low detection probability. Accordingly, the summing process of multiple looks according to the invention provides a robust method of converting a set of individually questionable detections into a composite detection exhibiting a higher order of detection probability.

Further the invention enables smaller airgun systems to be mounted on smaller craft while achieving the same detection probability at ranges as previously set forth for single band detection analysis.

Briefly described, the system and method according to the invention utilizes matched filter processing of a broadband return. Such a return (with or without target present) may be for each beam of a multibeam (multidirectional) sonar receive array.

The multi-beam matched filter outputs may be presented on one or more sonar displays. Selected outputs which appear to exhibit a moving target response above a noise threshold may be combined, as by summing, to provide a display of enhanced probability that a moving target has been detected. The selection of the outputs may be automated and the display may present target range, velocity and bearing.

The foregoing and other features and advantages of the invention may become more apparent from a reading of the following description in connection with the accompanying drawings in which

FIG. 1A is a plot showing probability of detection vs number of looks (bands) as a function of the initial look PD (probability of detection). Initial look PDs are identified as 20%, 30% and 50%;

FIG. 1B is a plot of signal to noise ratio vs probability of detection which relates the initial looks to a received signal level.

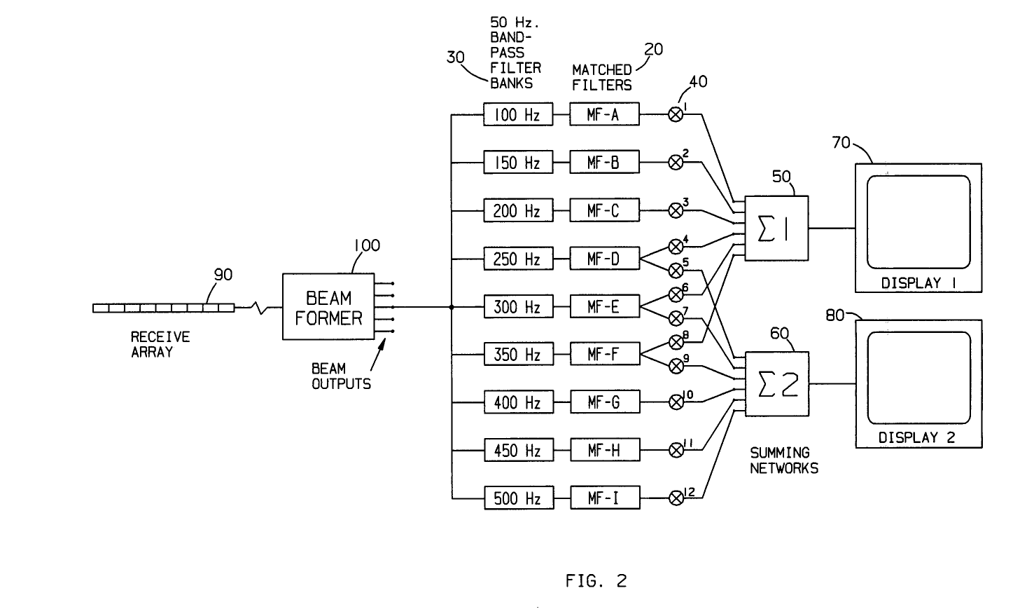

FIG. 2 is a block diagram of the receive portion of a sonar system including a processor in accordance with the invention;

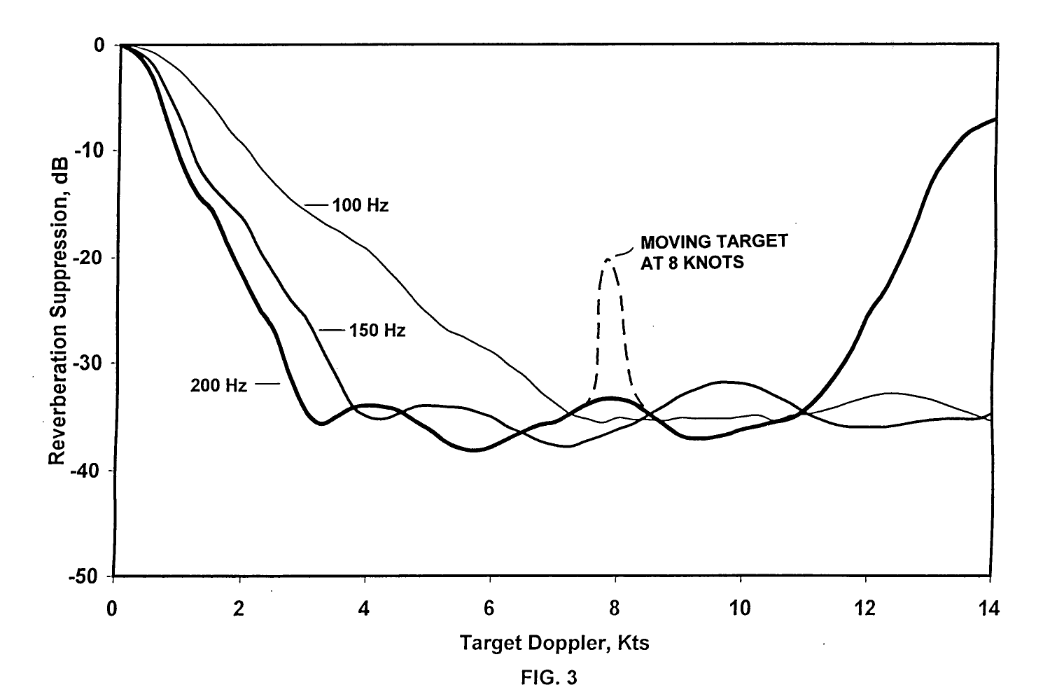

FIGS. 3, 4 and 5 are plots of match filter outputs and sums thereof for different selected bands which may be provided in the system of FIG. 2;

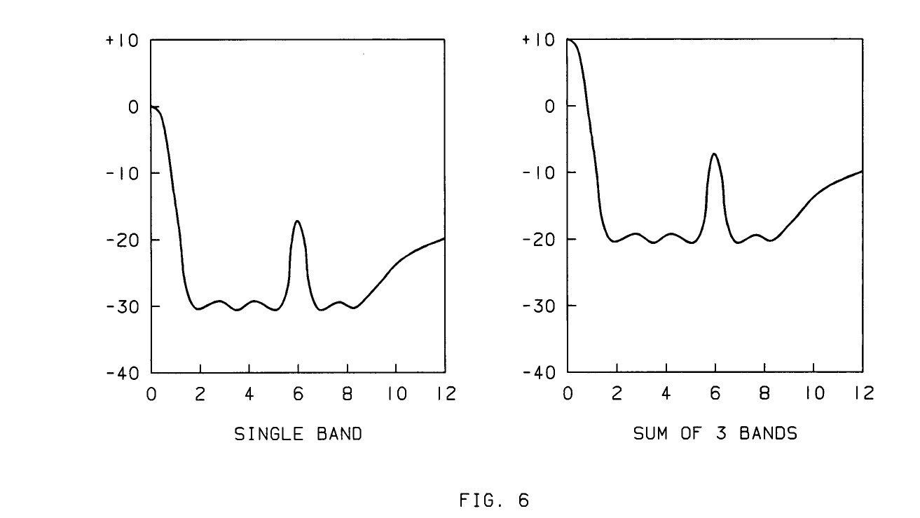

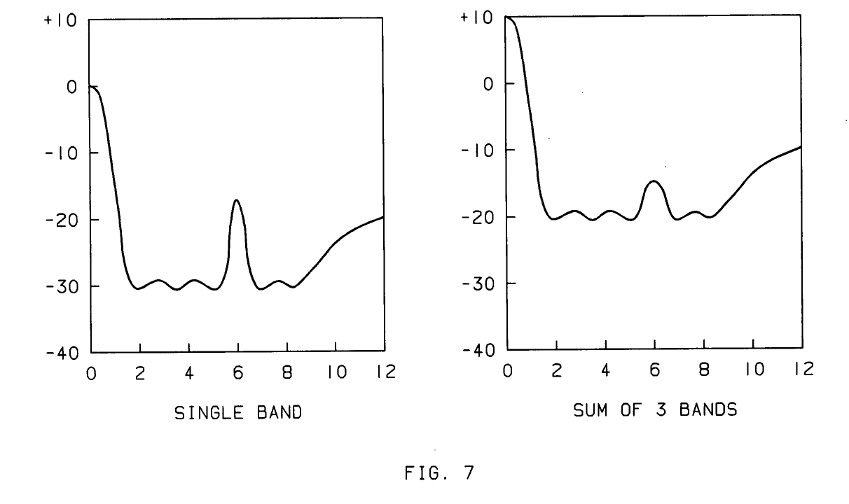

FIGS. 6 and 7 are different exemplary displays obtained with the system of FIG. 2;

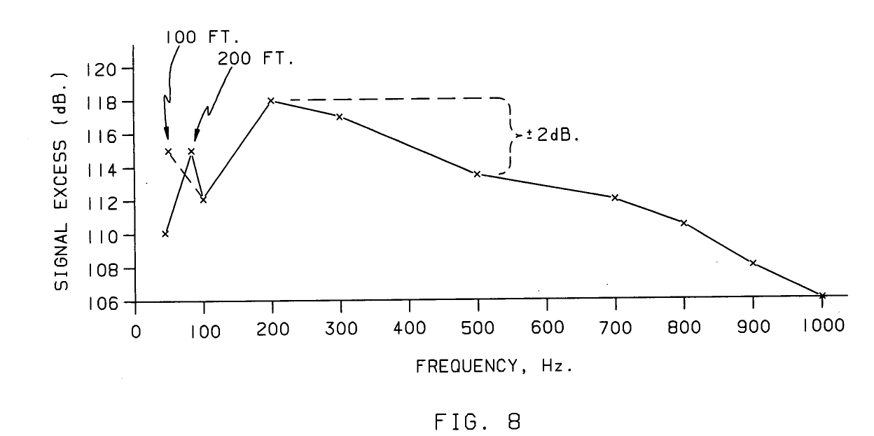

FIG. 8 is a plot of the broadband spectrum of a multiple pulse train produced by an array of airguns; and

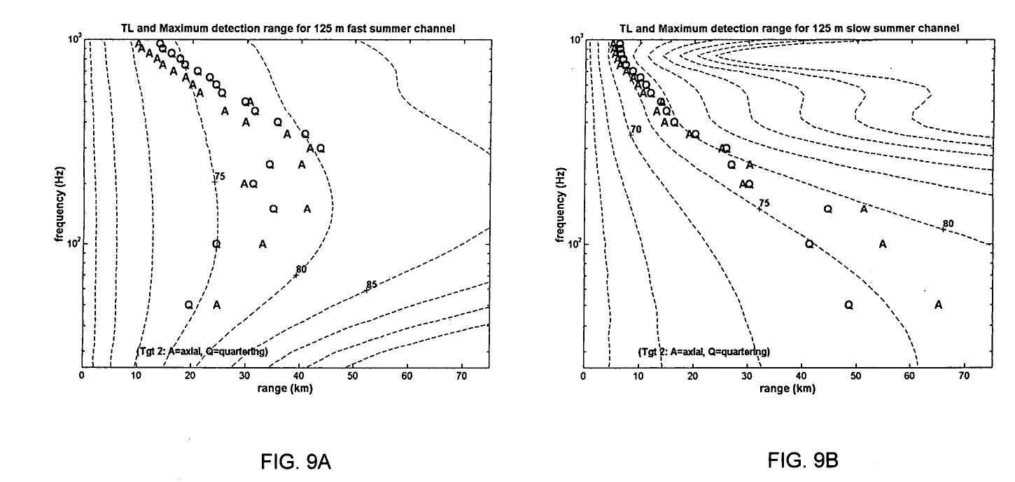

FIGS. 9A and B are plots of target detection ranges for targets in fast bottom and slow bottom channels, respectively as may be obtained using the system of FIG. 2.

For purposes of illustration of the invention, FIG. 2 illustrates essentially a presently preferred means for combining the outputs from a bank 20 of matched filters, each filter A-I associated with a different 50 Hz frequency sub-band obtained from 50 Hz band pass filters 30. The matched filters include replica banks as discussed above. At the output of each filter are one and two summing networks 50 and 60 whose outputs, in turn, are fed, for illustrative purposes to two displays 1 (70) and 2 (80).

The broadband returns from a multiple pulse airgun array transmission are received by a receive array 90, on one or more beams established by a beamformer 100 connected to the hydrophones of the array 90.

For example, Display 1 may present the sum of matched filters A, B, and C, while Display 2 shows the sum of matched filters D, E and F. This display also has the option of examining any one or other combination of these six frequency bands from center frequencies of 100 Hz to 350 Hz by the use of the selection switches 1 through 8. The switches may also be used to turn off selected bands that may be contaminated by extraneous noise sources.

Display 2 has access to six matched filters, three of which (D, E and F) also feed Display 1.

Display 2 has unique access to matched filters G, H and I as does display 1 to matched filters A, B and C. Such combining relationships as shown are arbitrary and employed here only for the purposes of illustration.

By the use of the switches 1 through 12 in the example of FIG. 2 a variety of display options are available to the operator providing for the presentations of single band outputs and summed combinations up to 6 outputs.

Generally, for the longer range detections in shallow water the six bands with center frequencies ranging from 100 Hz to 350 Hz will likely be preferred. For closer in targets the 400,450 and 500 Hz bands may be desired. Further, as will be noted bottom conditions can influence dramatically the frequency regimes best selected for target detection.

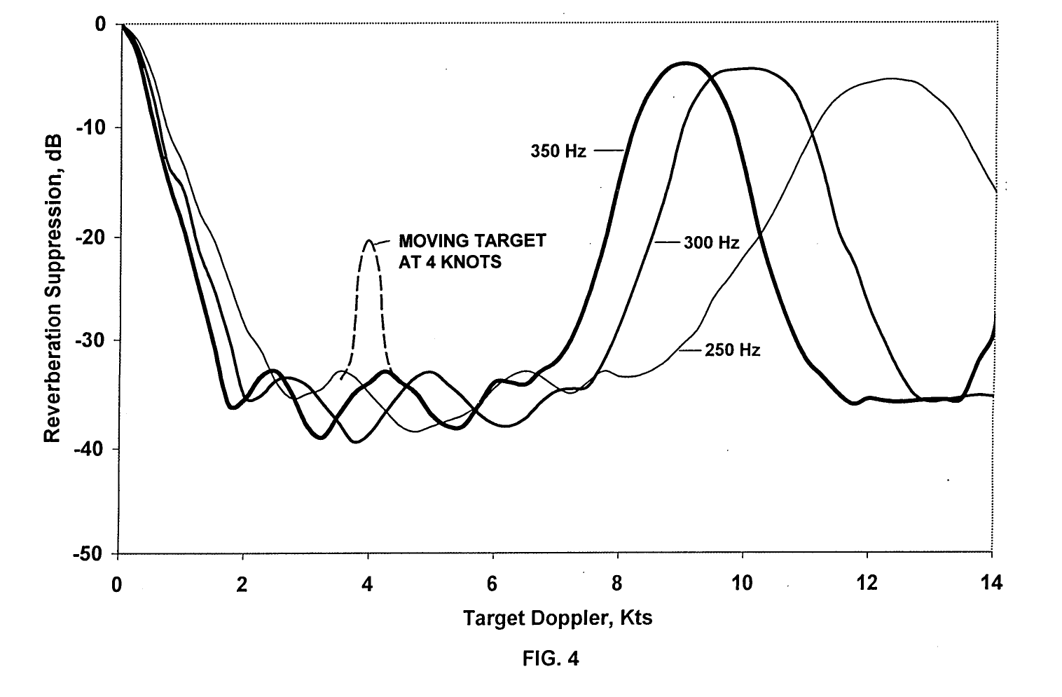

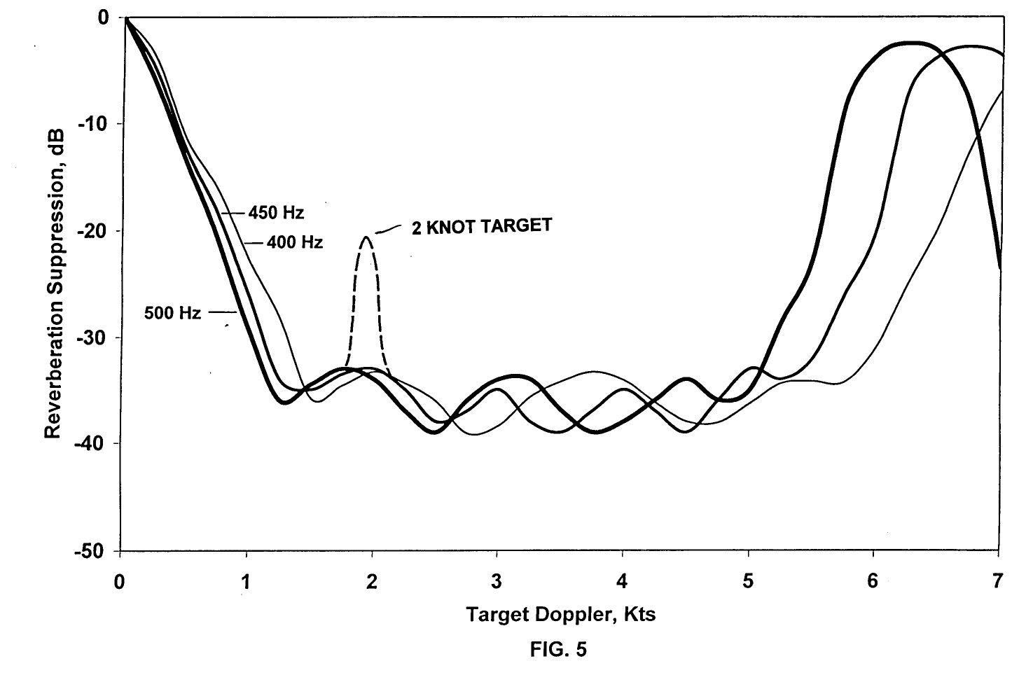

Examples of the matched filter responses for a 21 shot tapered sequence of impulses at ½ second repetition rate are shown in FIGS. 3, 4 and 5. These responses illustrate the level of reverberation suppression that can be obtained versus target Doppler. The frequencies noted are the center frequencies of the respective 50 Hz analysis bands. With three bands in each of FIGS. 3, 4 and 5, the total frequency range illustrated extends from center frequencies of 100 Hz to 550 Hz. Note that in FIG. 5 the Doppler scale has been changed from 1 to 14 knots (as in FIGS. 3 and 4) to 1 to 7 knots, providing, for the higher frequencies involved, improved detection of low velocity targets down to the range of 1 knot.

As an example, FIG. 3 shows the matched filter outputs for three, 50 Hz wide frequency bands with center frequencies of 100, 150, and 200 Hz. Overlaid on these curves is a candidate target response at 8 knots. If the −35 dB or so floor of the matched filter response corresponds to the noise floor as well, the 14 dB or so excess of the target response over this noise floor, as illustrated, should correspond to a probability of detection of about 50% when processed in one 50 Hz band at a time.

FIGS. 4 and 5 illustrate similar 3 band examples. As the frequencies increase the ambiguity lobes near 0 knots tend to sharpen enabling easier detection of slow moving targets. This can be seen from the 2 knot target response in FIG. 5 for the 400, 450 and 500 Hz bands. The slow target is clearly differentiated from the 0 velocity ambiguity whereas it would be obscured in the low frequency bands of FIG. 3.

FIG. 6 sets forth a candidate operator display in which band groupings can be compared with single band responses to give an immediate assessment of the robustness of the detection.

For example in this presentation the left-hand trace is for a single 50 Hz band response in a given beam. Its indicated amplitude suggests (for purposes of illustration) a probability of detection of 50%.

The right-hand trace in the figure is for the sum of three bands, each band exhibiting the target at a 50% PD. Note that the ordinate scale in this figure is elevated by 10 dB to reflect the summing of the three bands.

The shape of the curves is identical except for the displacement in floor levels.

The fact that the level of the target response in the right-hand trace has increased by about 10 dB over that of the left-hand trace is a direct indication that the target is exhibiting roughly the same PD in each of the three bands. According to FIG. 1 the PD has increased to 80%.

FIG. 7 illustrates, respectively, a case where the moving target appears to be present in 1 band only. The summation of 3 bands indicates a degraded response indicative of a false alarm.

As the bands are summed, a robust target detection will retain its integrity and the detection probability will, have increased. Conversely, if the response happens to be an artifact, and is not replicated in adjacent bands, the net response on summing will have diminished.

FIG. 8 sets forth a plot of the signal excess in dB for the airgun source spectral output relative to ambient noise. The airgun may be an array as shown in J. V. Bouyoucos U.S. Pat. No. 5,995,452 issued Nov. 30, 1999. The airgun signal excess over noise peaks between 200 Hz and 300 Hz and exhibits a ±2 dB bandwidth extending from about 50 Hz to 500 Hz. Propagation characteristics can control frequency choice as is noted above.

FIG. 9 sets forth the detection range estimates (at a 50% PD) for a 28 airgun array and for a 125M (meter) channel. The receive array may be a towed array. Two cases are illustrated, the case in FIG. 9 A is for a sandy, hard bottom while the case for FIG. 9B is for a bottom having a 4M sediment layer overlay as found in many areas near the mouth of a major river. The mean target strength for this example is 5 dB. The Q's on the plots identify detection ranges (at 50% PD) for a quartering aspect target as a function of frequency in 50 Hz increments over the range from 50 Hz to 1000 Hz. The A's represent axial aspect detections over the same frequency range. For the hard, sandy bottom propagation best supports the frequency region between, say, 150 Hz and 400 Hz. For the sediment layered bottom frequencies below 150 Hz are seen to be preferred.

It can be recognized that the airgun system's range of center frequencies, extending from 50 Hz to 500 Hz, effectively encompasses the regimes of maximum detection potential for these cases.

The act of selective band summing, as described above, can solidify detections by enhancing their probability without a significant loss of detection range. In this regard, it is important to note that for a single 50 Hz band alone, with its Q point representing a 50% PD, one would have to step back in two-way propagation loss by about 6 dB from the maximum shown to achieve an 80% PD, or to about 65% in range. This same improvement in PD to 80% is obtained in a 3 band summing operation with a minimal modification in range, depending on the curvature of the propagation loss versus frequency.

In summary the invention provides an improved band combining processing system and method and, as has been illustrated, provides for an efficient and displayable increase in detection probability of a moving target in a reverberant environment. The method, involving the summing of selected analysis bands according to the invention, provides an enhanced probability of moving target detection.

As the operator has multiple receiver beams to keep track of, the use of simplified and enhanced means for ascertaining a moving target at extended ranges on any given beam is a desirable option. The procedures outlined above are compatible with providing the operator an automated alert of moving target presence on any given beam. This automation process may be realized through a threshold sensor associated with each of the frequency bands (or sets of bands) in the analysis hierarchy. Such sensor may ring an alarm or trigger the automated presentation of the particular beam display to an operator (or both). The improvements outlined reduce the need for the operator to focus on a large multiplicity of 50 Hz analyses bands, and provides through the band summing approach, an enhanced and simplified detection procedure for a given beam. Further the ability to use a target velocity detection provides an inherent classification of moving over non-moving targets, and can reduce the prevalence of false alarms.

The multiple pulse transmissions can be augmented by spaced, single shots (or shot triplets) to help detect a stationary target through other classification tools such as spectral analysis, without adversely affecting the operation of the system provided by the invention.

As described above, the probability of detection of an underwater moving target, insonified by a broadband, multiple pulse transmission sequence, may be enhanced by a critical two-step process.

First, matched-filter processes, using replicas of the transmitted pulse train, are applied concurrently to a multiplicity of narrow (e.g., 50 Hz wide) frequency bands of the broadband echo response obtained from the receiver array. Such matched filter processing can suppress reverberation and provide a moving target response at the target's velocity.

Second, selected ones of said processed, moving-target return data sets are summed to create a composite moving target return in ambiguity space. The amplitude of this composite return with respect to the amplitude of the ambiguity background can help to quantify and enhance the probability that the system has detected a coherently responding, moving target.

In particular, a robust response in which the moving target amplitude is enhanced by an amount comparable to the enhancement of the ambiguous side lobes is quantitative evidence of an increase in target detection probability.

On the other hand, a reduced response by which the target amplitude weakens relative to the ambiguous side lobe responses following the summing process can reduce operator confidence in detection likelihood.

Variations and modification of the herein described system within the scope of the invention may become apparent to those skilled in the art. Accordingly, the foregoing description should be taken as illustrative and not in a limiting sense.

1. A method for processing broadband echoes received from a target subject to a multiple pulse, broadband transmission which method comprises the steps of band pass filtering said received signals into a multiplicity of sub-bands of said broadband transmission, matched filter processing each of said sub-band signals to provide sub-band matched filtered outputs, combining selected ones of said outputs to provide at least one combined output, and using said combined output for enhanced detection of said target.

2. The method of claim 1 including the step of selecting different outputs for combining.

3. The method of claim 1 wherein said selecting step is carried out based upon the amplitude of a response in said outputs representative of a moving target.

4. The method of claim 3 wherein said selecting step is carried out by responding to each of said sub-band signals and selecting for combining those of said sub-band signals which indicated collectively said moving target at a certain velocity.

5. The method of claim 1 wherein said combining step is carried out by selectively summing different ones of said sub-band signals.

6. The method of claim 5 wherein said summing step is carried out on different groups of said sub-band signals to provide a plurality of said summed outputs.

7. The method of claim 4 wherein said detection step is carried out by visual inspection of the display of said summed sub-band signals.

8. The method of claim 1 wherein said broadband signals are provided by a succession of timed underwater impulse events.

9. The method of claim 8 wherein said timed impulse events are provided by an airgun array.

10. The method of claim 1 wherein said received signals are provided from one or more of a plurality of beam directions with the aid of a directional hydrophone array, and said steps of separation, processing and summing steps are carried out independently for each beam direction to enable the provision of directionality in said detection step.

11. In a system for sonar signal processing of returns from broadband transmissions by matched filter processing of said returns in a multiplicity of sub-bands, the improvement comprising at least one summer for summing the outputs from said matched filters to provide at least one summed output for use in improved detection of targets from said returns.

12. The invention of claim 11 further comprising means for applying selectively said outputs to said summer.

13. The invention of claim 11 further comprising means for detecting said target from summed signals provided by said summer.

14. The invention of claim 12 further comprising a plurality of said summers to each of which are connected to different groups of said outputs forming sub-bands in lower and higher frequency portions of said broadband transmission.

15. The invention of claim 13 further comprising means for selecting said outputs for application to said summer by connecting only those outputs to said summers having a response greater than a certain threshold.

16. The invention of claim 15 which comprises means responsive in displaying of said individual outputs for operating said selecting means, and for displaying said summed outputs for use in detecting said targets.

17. In a system of sonar signal processing of returns which are divided into return events having different characteristics, the improvement comprising at least one combiner for combining said events to provide a combined output which represents a detection of a target exhibiting an enhanced probability of detection over the probability obtained from individual ones of said events.

18. A method for processing a broad frequency band echo return from an underwater moving target subjected to an incident transmission provided by a sequence of broadband impulses, said method comprising the steps of bandpass filtering said echo return to provide a multiplicity of sub-band responses, matched-filter processing said responses against a set of moving-target replicas for generating outputs representing initial detection of said moving target in said multiplicity of sub-bands, and combining the outputs of a selected set of said sub-bands to enhance the probability of detection of said moving target.

19. The method of claim 18 wherein said combining step is carried out by summing said selected outputs.
